(19) United States
(12) Patent Application Publication
(10) Pub. No.: US 2026/0084800 A1
(43) Pub. Date: Mar. 26, 2026

(54) FOAM INTERIOR WINDOW HOUSING WITH INTEGRATED FUNCTIONAL COMPONENTS, WINDOW MODULE, WINDOW, AIRCRAFT HAVING THE WINDOW AND METHOD OF PRODUCING THE WINDOW HOUSING

(71) Applicant: Diehl Aviation Laupheim GmbH, Laupheim (DE)

(72) Inventor: Nicolas Roblicka, Ulm (DE)

(21) Appl. No.: 19/336,596

(22) Filed: Sep. 23, 2025

(30) Foreign Application Priority Data
Sep. 26, 2024 (DE) 10 2024 127 954.0

(51) Int. Cl. B64C 1/14; B29C 44/12; B29L 31/30

(52) U.S. Cl. CPC B64C 1/1484; B29C 44/12; B29L 2031/3082

(57) ABSTRACT

A window housing for a window of a passenger cabin of an aircraft having a fuselage pane and an inner pane. The window includes between the inner pane and the fuselage pane, a window funnel, which is fastened in the aircraft and is made of foam. The housing further includes a functional component fastened to the window funnel. A window module for the window includes the window housing and the inner pane. A window for the passenger cabin of the aircraft includes the fuselage pane, the inner pane and the window housing. An aircraft includes the passenger cabin with at least one of the windows in the mounted state in the aircraft.

### CROSS-REFERENCE TO RELATED APPLICATION

This application claims the priority, under 35 U.S.C. § 119, of German Patent Application DE 102024127954.0, filed Sep. 26, 2024; the prior application is herewith incorporated by reference in its entirety.

### FIELD AND BACKGROUND OF THE INVENTION

The invention relates to a window of a passenger cabin of an aircraft, wherein, along a viewing direction, the window has a fuselage pane that is integrated into a fuselage of the aircraft and extends transversely to the viewing direction, and, at a distance therefrom, an inner pane on the cabin side extending in parallel. The window also has a window funnel, which extends along the viewing direction surrounding the latter between the inner pane and the fuselage pane.

Published, non-prosecuted German patent application DE 10 2007 006 540 A1, corresponding to U.S. Pat. No. 8,157,214, discloses an aircraft window arrangement. This contains a window funnel, on which a retaining ring for fastening a window pane on the cabin side is arranged. The window funnel extends substantially from the side wall lining of the aircraft cabin to an outer pane of the aircraft.

### SUMMARY OF THE INVENTION

The object of the present invention is to propose improvements in relation to such a window.

The object is achieved by a window housing according to the independent window housing claim. Preferred or advantageous embodiments of the invention and other categories of invention can be gathered from the further claims, the following description and the appended figures.

The window housing is for a designated window of a passenger cabin of an aircraft. The invention is based on the following window/passenger cabin/aircraft: the window has a fuselage pane. This is integrated into a fuselage of the aircraft and extends transversely to a viewing direction. The latter leads from the passenger cabin through the window to the outside of the aircraft.

Opposite to, but along, the viewing direction, the window has an inner pane on the cabin inside at a distance from the fuselage pane. The inner pane extends parallel to the fuselage pane. The inner pane is also called “interior window (on the inside of the cabin)”. The aircraft is in particular a passenger aircraft.

“Designated” means that the window housing is matched in design terms to specific or specific types of windows, passenger cabins and aircraft and is configured to be used there; for example designed for the geometry and material requirements etc. determined thereby. In other words, in particular relevant windows, passenger cabins and aircraft are assumed as known with regard to their geometry and material properties etc. Specifically, therefore, the properties of windows, passenger cabins and aircraft mentioned in the present case are assumed.

The window housing includes a window funnel. This can be fastened in the aircraft, in particular to the fuselage/a structural part of the aircraft/fuselage or, in an intended mounted state of the window housing, actually fastened in the passenger cabin/the aircraft. In the mounted state, the window funnel extends along the viewing direction between the inner pane and the fuselage pane. In so doing, it surrounds the viewing direction and the space between the two panes.

The term “extends between” is to be understood broadly here: the window funnel can end on the inner pane or, in the viewing direction, in front of or behind the latter, in particular the window funnel projects towards the aircraft interior, i.e. inwards, beyond the inner pane. Alternatively or additionally, the window funnel ends on the fuselage pane or inside the cabin in front of the fuselage pane.

The window funnel is made of foam.

The window housing includes at least one functional component, which is fastened to the window funnel. The fastening can be made, for example, in that following the production/foaming of the window funnel, the functional component is introduced into the finally foamed window funnel or fastened to the latter.

In particular, the installed window funnel effects light-tight bridging between the two panes (inner pane, fuselage pane). In particular, “functions” are integrated in the window funnel by means of specific shaping of the foam. Such a function can, for example, be an attachment function for the inner pane. To this end, for example, a contact surface for the inner pane is then formed on the foam, wherein, in the mounted state, the inner pane then rests on the contact surface of the window funnel and is thus functionally fixed with respect to the latter there.

The use of the foam/foam material—in particular particulate foam—offers the following advantages as opposed to an injection-moulded material:
the density is about 10-20 times lower (weight reduction by about 25%),
improved damping properties in relation to the acoustics, and
lower thermal conductivity.

The foam combines the following properties, which contribute to improving the window housing:
structure of the window funnel and integration of the functional components,
lower heat transmission as opposed to the injection-moulded part known from practice, and
better acoustic properties as opposed to the injection-moulded part known from practice.

In a preferred embodiment, the foam is a particulate foam. In other words, this is therefore a particulate foam which is commonly formed from foam particles (beads), which are fused to one another in a mould. Such components can be made from particulate foam particularly well and with high quality. In other words, the window funnel is made of foam, particulate foam being chosen as the preferred material variant.

In a preferred embodiment, at least one of the functional components is fastened to the window funnel by being foamed into the foam as an insert. As a result of appropriate foaming-in, the functional components can be fastened particularly simply and effectively to the window funnel.

In a preferred embodiment, at least one of the functional components is a fastening component. The fastening component is one by means of which the window housing can be fastened to the aircraft, i.e. to a fuselage/structural part of the aircraft/of the passenger cabin (and is fastened in the mounted state). Such structural parts are, for example, the fuselage or attachments to the latter, internal lining of the passenger cabin, a basic frame, strutting in the aircraft/in the passenger cabin etc. For example, the fastening component is a flange having a hole, in order to screw the window funnel to the structural part with the aid of a screw. The fastening component can, however, also be a guide or holder for a further or secondary fastening means such as, for example, a dowel, a clamp or a clip. Finally, the further fastening means then performs the actual fastening of the window funnel—indirectly via the fastening component—to the structural part.

As a result of the integration of such fastening components in the window funnel, the latter can be fastened particularly well in the aircraft.

In a preferred embodiment, it is assumed that the designated window includes a retaining element, wherein the retaining element is or can be fastened to the window funnel (and possibly re-detachably). The retaining element, in particular together with the window funnel, is configured to retain the inner pane on the window funnel. The retaining element is, for example, a retaining ring. Together with the window funnel, the latter is configured to fix the inner window in a form-fitting manner between the retaining ring and the window funnel or to clamp the same between them in the viewing direction.

At least one of the functional components is then a retaining component, which is configured to retain or to fasten the holding element on or to the window funnel. By virtue of the retaining component, the retaining element and thus also the inner pane can be fastened particularly well to the window funnel.

In a preferred variant of this embodiment, it is assumed that the retaining element has a form-fitting mating element. The retaining component is then a form-fitting component which is configured to interact with the form-fitting mating element of the retaining element in a form-fitting manner in the mounted state, in order to fasten the retaining element to the window funnel. By means of an appropriate form fit between the form-fitting component and the form-fitting mating element, the retaining element can be fastened particularly well to the window funnel in a form-fitting manner.

In a preferred variant of this embodiment, it is assumed that the form-fitting mating element is a latching lug. The form-fitting component is then an undercut for the latching lug (e.g. a stop shoulder/plate).

Alternatively, the converse variant may also be possible: the form-fitting mating element is the undercut and the form-fitting component is the latching lug. This results in a particularly simple and effective form fit which can also be latched, i.e. simplifies the mounting of the retaining element on the window funnel.

In a preferred embodiment, it is assumed that the window includes a blind. The blind is configured to darken the window more or less as required. To this end, the blind is adjustable (e.g. by a passenger in the passenger cabin). The blind is, for example, a slider or a roller blind, and in particular is designed to be light-tight. By means of adjusting, displacing or operating the blind, the window can therefore be darkened more or less or not, so that more or less light from outside the aircraft can enter the aircraft cabin or not.

At least one of the functional components is then a guide component for the blind, in order to be able to adjust the latter with the aid of or by means of guidance by the guide component (in order, therefore, to darken the window not at all, more or less or completely). The guide component is, for example, a sliding/running rail for a slider, which is then displaceable along the rail.

Thus, the window housing (at least partly) also performs the function of the guidance of the blind, for which reason a possibly supplementary blind guide outside the window housing can be configured more simply or the latter can be dispensed with entirely.

In a preferred embodiment, at least two of the functional components are configured jointly as a combination part in the form of a single insert for the foam of the window funnel. In particular, the combination part is formed in one piece. For example, the combination part is a window frame which at least partly surrounds the window funnel (circumferentially around the viewing direction). This can be configured, for example, as the running rail for the blind, on which form-fitting components for the form-fitting mating elements and retaining components for the retaining element and fastening components for the fastening of the window funnel to structural parts of the aircraft are moulded (e.g. attached via webs). It is thus possible, for example, that, for example, only the combination part has to be inserted into a tool or a foam mould for the window funnel as a single insert. The foam mould can then be foamed with foam in order to produce the window funnel. All the desired functions (of the functional components) are then integrated into the window funnel in one step. Thus, all the functional components can therefore be attached to the window funnel in one operation and the latter can itself be produced.

The object is also achieved by a window module according to the independent window module claim. This includes the window housing and the inner pane, as have already been described above, wherein the window housing and inner pane are in the mounted state.

The background to this is as follows: the fuselage pane is not part of a so-called “window unit”, i.e. the window module. The fuselage pane is generally permanently installed in the aircraft. The window funnel merely adjoins the fuselage window/the fuselage pane. The window housing/window module is in particular fastened to the interior side wall. The complete interior side wall with interior window then forms one subassembly. As it is mounted in the aircraft, the complete subassembly is inserted into the aircraft and, during the mounting, forms the transition from the fuselage window/fuselage pane to the interior.

The window module and at least some of its possible embodiments and the respective advantages have already been explained analogously in conjunction with the window housing according to the invention. In particular, therefore, the preferred embodiments mentioned above in connection with the window housing also form preferred embodiments of the window module.

The object of the invention is also achieved by a window according to the independent window claim, as has already been described above. The window is therefore one for the designated passenger cabin of the aircraft, as has been described above. The window includes—as explained above—the fuselage pane that can be integrated into the fuselage of the aircraft (and is integrated in the intended mounted state), and the inner pane which, in the intended mounted state, is arranged at a distance from and parallel to the fuselage pane. The window includes the window housing according to the invention. In particular, the inner pane is fastened to the window funnel.

The window and at least some of its possible embodiments and the respective advantages have already been explained analogously in connection with the window housing according to the invention. In particular, therefore, the preferred embodiments mentioned above in connection with the window housing also form preferred embodiments of the window.

The object of the invention is also achieved by an aircraft according to the independent aircraft claim, as has already been explained above. This includes—as explained—the passenger cabin mentioned above and at least one of the windows (and therefore the window housing) mentioned above which, in the intended mounted state, are located in the aircraft or the passenger cabin.

The aircraft and at least some of its possible embodiments and the respective advantages have already been explained analogously in connection with the window housing according to the invention and the window according to the invention. In particular, therefore, the preferred embodiments mentioned above in connection with the window housing and the window also form preferred embodiments of the aircraft.

The object of the invention is also achieved by a method according to the independent method claim. This is used to produce the window housing according to the invention, as has been explained above, in particular in the aforementioned embodiment with at least one functional component which is foamed in the foam/in particular particulate foam as an insert.

In the method, a foam mould for the window funnel is provided. In particular, the functional components (inserts) to be foamed-in are inserted into the foam mould. As a rule, these are fixed in order—after the following foaming—to be located at an intended position in the window funnel. The window funnel is then made by introducing the foam into the foam mould (therefore over-foaming). During this process (foaming-in) or subsequently (subsequent fastening), the functional components are fastened to the window funnel—in particular by foaming-in/over-foaming.

The method and at least some of its possible embodiments and the respective advantages have already been explained analogously in connection with the window housing, window and aircraft according to the invention. In particular, therefore, the preferred embodiments mentioned above in connection with the window housing and the window and the aircraft also form preferred embodiments of the method.

The invention is based on the following findings, observations and considerations and also has the following preferred embodiments. These embodiments are also to some extent called “the invention” for the purposes of simplification. Here, the embodiments can also include parts or combinations of the above-mentioned embodiments or correspond to these and/or possibly also include embodiments not previously mentioned.

According to the invention, the result is a foam interior window housing with integrated functional components for the air travel sector.

The subassembly “foam interior window housing” is used in particular to bridge the interior window (cabin inner side, inner pane) to the fuselage window (fuselage pane) in a light-tight manner in aircraft. As opposed to window housings known from practice, the aforementioned component (window funnel) is made of a lightweight foam material. Functions are appropriately integrated into the foam housing and/or via over-foamed inserts (functional components).

The invention is based on the idea of devising a reduction in weight of the aircraft interior side wall.

The invention is based on the observation that, in practice, appropriate subassemblies of the window housing (window funnels) are primarily constructed from injection-moulded parts.

According to the invention, the injection-moulded housing is replaced by a foam housing (window funnel). The density of the foam is considerably lower than that of the injection-moulded material. Functions are appropriately integrated into the foam housing and/or via over-foamed inserts.

The construction (window housing) needs in particular various stand-alone over-foamed inserts (functional components) in order to fulfil the functions of products (window housing) known from practice. The foam design is at the same time an integral design. It primarily performs the structural formation of the window housing and at the same time has a lower thermal conductivity with improved acoustic damping properties.

The foam housing (window funnel) performs the absorption of force and the guidance of functional components and also the shielding of the light from the fuselage window (fuselage pane) to the interior wall. The wall thickness of the foam design is thicker as opposed to injection-moulded housings known from practice. Functions are appropriately integrated into the foam housing and/or via over-foamed inserts. The inserts are fastened to appropriate tool devices (foam mould) and then back-foamed (foaming of the window funnel). The tool (foam mould) is used for the placement of the inserts (in the window funnel) and is in particular shaped such that undercuts (form-fitting component) can be implemented.

Other features which are considered as characteristic for the invention are set forth in the appended claims.

Although the invention is illustrated and described herein as embodied in a foam interior window housing with integrated functional components, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a detail of an aircraft and its passenger cabin having a window with a window housing;

FIG. 2 is a sectional view through the window housing from FIG. 1 taken along the line II-II;

FIG. 3 is a perspective view of detail III shown in FIG. 1;

FIG. 4 is a perspective view of a combination part from FIG. 3, omitting the window funnel; and

FIG. 5 is a perspective rear view of the window housing from FIG. 1 in the direction of the arrow V with a fastening component as a holder for a secondary fastening means.

### DETAILED DESCRIPTION OF THE INVENTION

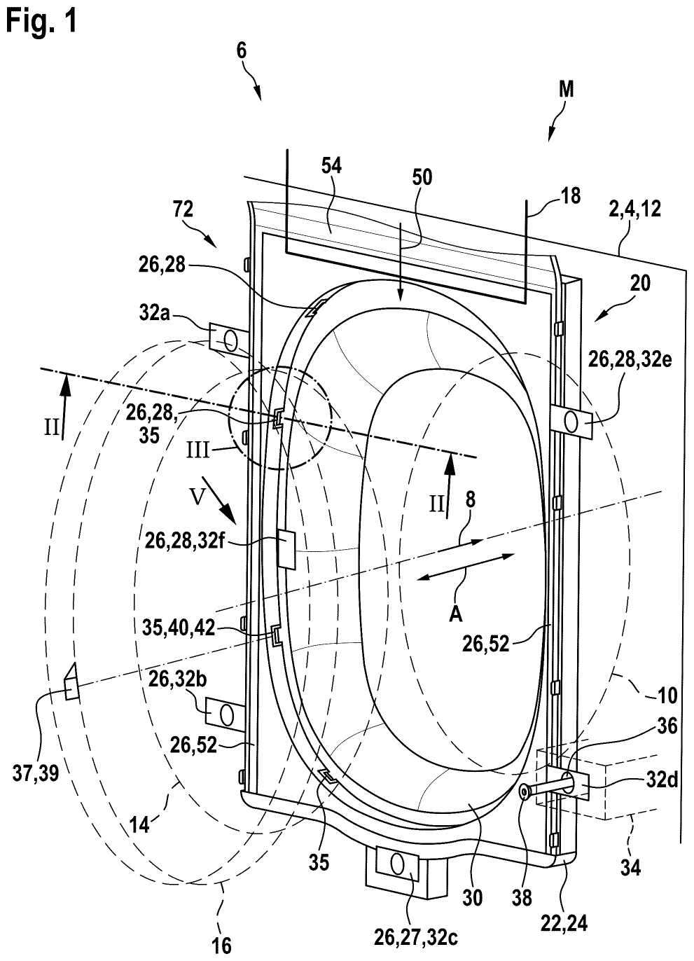

Referring now to the figures of the drawings in detail and first, particularly to FIG. 1 thereof, there is shown a detail from an aircraft 2, namely from its passenger cabin 4. These include a window 6. The window 6 is located in the aircraft 2 in a mounted state M.

Along a viewing direction 8, which is directed from the passenger cabin 4 to the outside of the aircraft 2 (arrow in FIG. 1), the window 6 has an inner pane 14 and a fuselage pane 10. The latter is integrated into a fuselage 12 of the aircraft 2 and extends transversely to the viewing direction 8. The inner pane 14 extends parallel to the fuselage pane 10 at a distance A along, but opposite to, the viewing direction 8.

The window 6 includes a window housing 20. The window housing 20 includes a window funnel 22. The latter is, as explained, fastened to an interior side wall (not specifically illustrated) of the aircraft 2. Along the viewing direction 8, the window funnel 22 extends between the inner pane 14 and the fuselage pane 10. “Between” is to be understood broadly: the window funnel 22 projects beyond the inner pane 14 towards the passenger cabin 4 and extends as far as the fuselage pane 10, i.e. ends on the latter. The window funnel 22 encloses the two panes and the viewing direction 8 and therefore shields off the interspace between the inner pane 14 and the fuselage pane 10 in a light-tight manner with respect to its radially outer surroundings (as based on the viewing direction 8). The window funnel 22 is made of a foam 24, here particulate foam.

The window housing 20 additionally includes a plurality of functional components 26, explained in more detail further below, which, altogether, are fastened to the window funnel 22. In the example, all the functional components 26 are fastened to the window funnel 22 by the fact that they are foamed into the foam 24 as inserts 28.

The window 6 further includes a retaining element 16 which, in the mounted state M, is fastened to the window funnel 22 and retains the inner pane 14 on the window funnel 22. More precisely, the retaining element 16 clamps the inner pane 14 between itself and the window funnel 22 (a contact surface 30 on the latter) in the direction of the viewing direction 8.

For the purpose of improved visualization, FIG. 1 shows a partly exploded illustration of the situation with respect to the window funnel 22, inner pane 14 and retaining element 16.

The window funnel 22 has the following function merely as a result of its shape: the foam 24 is shaped to form the contact surface 30 which, in the mounted state M, points towards the passenger cabin 4 and on which the inner pane 14 rests flatly with its outer side facing the fuselage 12 and, as a result, is supported on the window funnel 22.

Four of the functional components 26 are designed as fastening components 32a,b,d,e. By means of the fastening components 32, the window funnel 22 is fastened to structural parts 34 of the aircraft 2, specifically here an interior side wall not specifically illustrated, of which only one is illustrated by way of example in the figure. The fastening components 32 are designed here as flanges having holes 36. With the aid of screws 38 through the holes 36, the fastening components 32 and therefore the window funnel 22 are fastened to the structural part 34 and therefore to the fuselage 12 of the aircraft 2.

The fifth functional component 26, as a fastening component 32c, is welded onto the window funnel 22 (finished foam component) as an attachment 27 without being an insert.

Eight of the functional components 26 are configured as retaining components 35 for the retaining element 16, in order to fasten the latter to the window funnel 22. Four of these retaining components 35 are visible in FIG. 1. In the example, the retaining element 16 has form-fitting mating elements 37, here in the form of latching lugs 39. The retaining components 35 are therefore form-fitting components 40 which, in the mounted state, interact with the form-fitting mating elements 37 in a form-fitting manner. The form-fitting components 40 are undercuts 42 here in the form of stop plates behind which, in the mounted state M, the latching lugs 39 engage with a form fit in order to press the retaining element 16 against the window funnel 22, clamping in the inner pane 14.

The window 6 includes a blind 18. This is configured to darken the window 6 as needed against ambient light from outside the aircraft 2, or not, in that the blind 18 is displaced partly or wholly in front of the inner pane 14 on the cabin side in the direction of the arrow 50—for example by a passenger (not illustrated). In order to reduce the darkening, the blind 18 can be displaced in the opposite direction to the arrow 50.

Two of the functional components 26 are designed as guide components 52 for guiding and therefore adjusting the blind 18. The guide components 52 are guiding or sliding or running rails for the blind 18, which is designed as a slider here, which extend here along the direction of the arrow 50. The guidance of the blind 18 is completed by a covering element (not illustrated) on the cabin side which, on the cabin side, retains the blind 18 in the guide components 52.

All the functional components 26 are designed in the present case jointly as a one-piece combination part 54 in the form of a window frame. The combination part 54 thus forms the single insert 28 for the window funnel 22 or its foam 24.

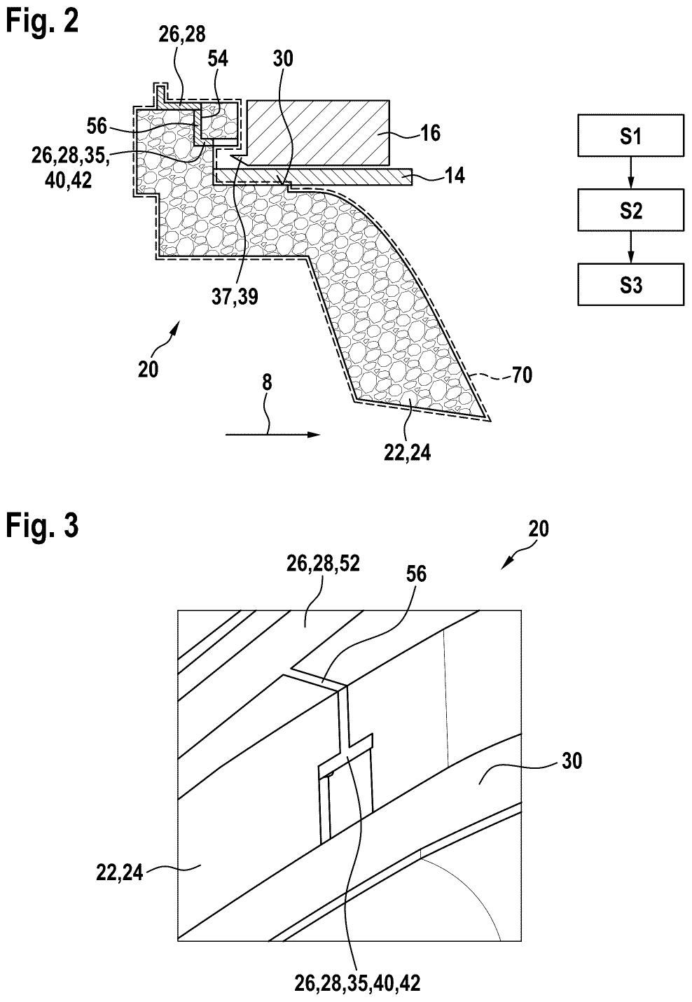

In FIG. 1, it can be detected or seen from the combination part 54 that the guide components 52 are configured as parts or longitudinal-web rails of the window frame. The fastening components 32 are in turn formed in one piece on the latter. The shaping of the retaining components 35 can be seen in FIGS. 2 to 4. These are moulded onto the remaining functional components 26 via webs 56 as part of the combination part 54.

FIG. 2 shows a section along the line II-II through the left-hand part of the window housing 20 in FIG. 1. It is possible to see here how the guide component 52 is connected to the retaining component 35 via the web 56 and the combination part 54 is foamed into the foam 24. In addition, the design of the retaining component 35 as an undercut 42 for the latching lug 39 on the retaining element 16 is illustrated symbolically here. A recess (not specifically explained) in the window funnel 22 is provided for the latching lug 39.

The window housing 20 and inner pane 14 together form a window module 72 which, during the mounting, is inserted as such into the aircraft having the already mounted fuselage pane 10.

FIG. 2 symbolises the method for producing the window housing 20.

In the method, in a step S1, a foam mould 70 indicated only dashed here is provided for the window funnel 22, which therefore defines the outer surfaces of the window funnel 22 to be created in a customary way by its internal volume or its inner wall.

For the case here of foamed-in functional components 26, these are fixed-here as the combination part 54—in the foam mould 70 in a step S2.

Then, in a step S3, the foam 24 is introduced into the foam mould 70 and the window funnel 22 is hereby made or foamed. The functional components 26 are also foamed in as the combination part 54 and, as a result of this foaming into the window funnel 22, are fastened in the window funnel 22 formed from the foam 24.

FIG. 3 shows the situation from FIG. 2 without the retaining element 16, once more in a perspective view as a detail III from FIG. 1. Here, it is in particular possible to see the guide component 52 in the form of a sliding rail, the web 56 and the retaining component 35 in the form of the undercut 42. In addition, the contact surface 30 for the inner pane 14 is to be seen.

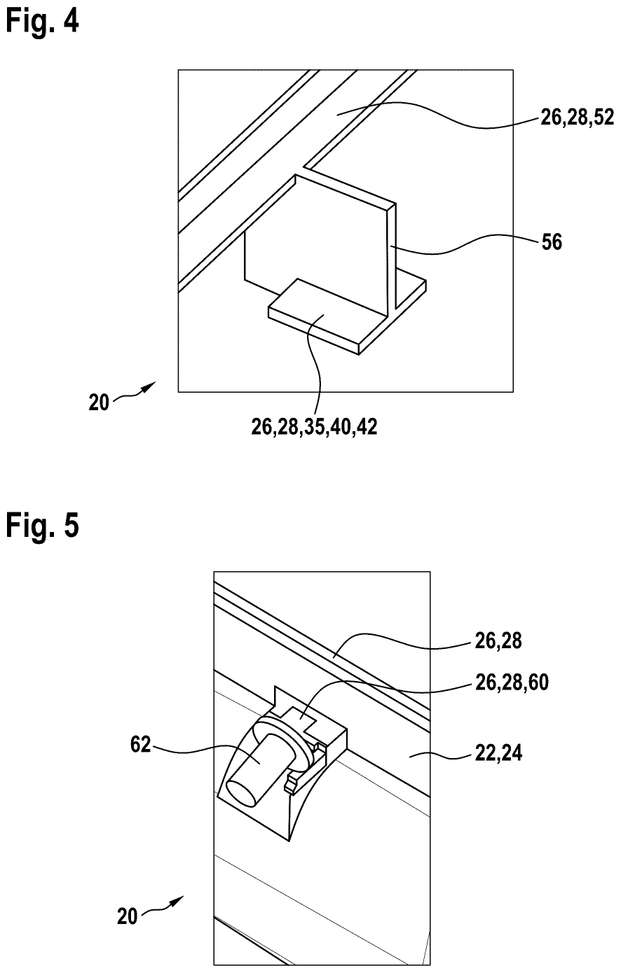

FIG. 4 shows the situation from FIG. 3 with the omission of the foam 24, for which reason the combination part 54 is illustrated on its own. The individual functional components 26 can thus be seen better.

FIG. 5 shows in the viewing direction of the arrow V in FIG. 1, that is to say in the oblique rearward viewing direction of the window funnel 22, a further fastening component 32f as a functional component 28. This is firstly or merely a holder 60 for a secondary fastening means 62. The fastening means 62 is a dowel here, which effects the actual fastening of the window funnel 22 to a further structural part 34 (not illustrated) of the aircraft 2. The fastening of the window funnel 22 is therefore carried out indirectly here, in that the fastening means 62 fastened directly to the structural part 34 is retained by the fastening component 32 and the latter is in turn fastened in the window funnel 22.

The following is a summary list of reference numerals and the corresponding structure used in the above description of the invention:
2 Aircraft
4 Passenger cabin
6 Window
8 Viewing direction
10 Fuselage pane
12 Fuselage
14 Inner pane
16 Retaining element (inner pane)
18 Blind
20 Window housing
22 Window funnel
24 Foam
26 Functional component
27 Attachment
28 Insert
30 Contact surface (inner pane)
32a-f Fastening component (on structural part)
34 Structural part (aircraft)
35 Retaining component (for retaining element)
36 Hole
37 Form-fitting mating element (on retaining element)
38 Screw
39 Latching lug
40 Form-fitting component (on window funnel)
42 Undercut
50 Arrow
52 Guide component (blind)
54 Combination part
56 Web
60 Holder
62 Fastening means (secondary to fastening component)
70 Foam mould
72 Window module
M Mounted state
A Distance
S1-3 Step

1. A window housing for a designated window of a passenger cabin of an aircraft, wherein, along a viewing direction, the window has a fuselage pane that is integrated into a fuselage of the aircraft and extends transversely to the viewing direction, and, at a distance along the viewing direction, an inner pane on a cabin side extending parallel to the fuselage pane, the window housing comprising:
a window funnel for fastening to the aircraft and, in a mounted state, extending along the viewing direction surrounding an opening in the fuselage between the inner pane and the fuselage pane, said window funnel being made of foam; and
at least one functional component fastened to said window funnel.

2. The window housing according to claim 1, wherein said foam is a particulate foam.

3. The window housing according to claim 1, wherein said at least one functional component is one of a plurality of functional components, at least one of said functional components is fastened to said window funnel in that it is foamed into said foam as an insert.

4. The window housing according to claim 1, wherein said at least one functional component is one of a plurality of functional components, at least one of said functional components is a fastening component, by means of said fastening component said window funnel is fastened to the aircraft.

5. The window housing according to claim 1, wherein:
the designated window includes a retaining element, which is fastened to said window funnel and is configured to hold the inner pane on said window funnel in the mounting state; and
said at least one functional component is one of a plurality of functional components, at least one of said functional component is a retaining component, which is configured to retain the retaining element on said window funnel.

6. The window housing according to claim 5, wherein:
the retaining element has a form-fitting mating element; and
said retaining component is a form-fitting component, which is configured to interact in a form-fitting manner with the form-fitting mating element of the retaining element in the mounted state.

7. The window housing according to claim 6, wherein:
the form-fitting mating element is a latching lug and said form-fitting component is an undercut for said latching lug; or
said form-fitting component is a latching lug and the form-fitting mating element is an undercut for said latching lug.

8. The window housing according to claim 1, wherein:
the designated window includes a blind which is configured to darken the designated window; and
said at least one functional component is one of a plurality of functional components, at least one of said functional components is a guide component for an adjustment of the blind.

9. The window housing according to claim 3, wherein said at least one functional component is one of a plurality of functional components, at least two of said functional components are configured jointly as a combination part in a form of a single insert.

10. A window module for a window of a designated passenger cabin of an aircraft, wherein, along a viewing direction, the window has a fuselage pane integrated into a fuselage of the aircraft and extends transversely to the viewing direction, the window module comprising:
an inner pane disposed at a distance along the viewing direction from the fuselage pane, on a cabin side extending parallel to the fuselage pane in a mounted state; and
said window housing according to claim 1.

11. A window for a designated passenger cabin of an aircraft, the window comprising:
an inner pane;
along a viewing direction, the window having a fuselage pane for integration into a fuselage of the aircraft and extending transversely to the viewing direction, and, at a distance therefrom along the viewing direction, said inner pane on a cabin side extending parallel to said fuselage pane in a mounted state; and
said window housing according to claim 1.

12. An aircraft, comprising:
a passenger cabin; and
at least one said window according to claim 11, said at least one window is disposed in the aircraft in the mounted state.

13. A method for producing a window housing, which comprises the steps of:
providing a foam mold for forming a window funnel;
introducing foam into the foam mold which makes the window funnel; and
fastening functional components to the window funnel during or after an introduction of the foam.
